(19) United States
(12) Patent Application Publication
(10) Pub. No.: US 2025/0062820 A1
(43) Pub. Date: Feb. 20, 2025

(54) Fast P3 Beamsweep Scheme

(71) Applicant: Nokia Technologies Oy, Espoo (FI)

(72) Inventors: Amol DHERE, Gistrup (DK); Christian ROM, Aalborg (DK); Poul OLESEN, Stovring (DK)

(21) Appl. No.: 18/721,740

(22) PCT Filed: Dec. 23, 2021
(86) PCT No.: PCT/EP2021/087534

§ 371 Date: Jun. 19, 2024

(51) Int. Cl. H04B 7/08; H04B 17/309; H04B 17/318

(52) U.S. Cl. CPC H04B 7/088; H04B 17/328; H04B 17/346

(57) ABSTRACT

Method including: determining, subsequently for each of X beams, a characteristic of a power of a reference signal received on the respective beam over a respective period of time; and identifying a best beam among the X beams such that the characteristic of the power of the best beam is extreme among the characteristics of the power received on the X beams over the respective period of time; wherein X is an integer equal to or larger than 2; each of the periods of time has a same duration denoted a slice duration; the slice duration is shorter than a duration of one symbol of the reference signal.

### FIELD OF THE INVENTION

The present disclosure relates to beam alignment.

### Abbreviations

3GPP 3rd Generation Partnership Project
5G/6G/7G 5^{th}/6^{th}/7^{th} Generation
ADC Analog to Digital Converter
ASK Amplitude-shift-keyed
BWP Bandwidth Part
CQI Channel Quality Index
CSI Channel State Information
CSI-RS Channel State Information Reference Signal
DAC Digital to Analog Converter
eNB evolved NodeB
FR Frequency Range
gNB next generation NodeB
HW Hardware
IF Intermediate Frequency
NACK Not Acknowledged
NZP Non-Zero Power
OFDM Orthogonal Frequency Division Multiplexing
PMI Precoding Matrix Indicator
RAN Radio Access Network
RFFE Radio Frequency Front End
RI Rank Indicator
RLM Radio Link Monitoring
RSSI Received signal strength indicator
RSRP Reference Signal Received Power
Rx Receive
SCS Subcarrier Spacing
SINR Signal to Interference and Noise Ratio
SSB Synchronization Signal Block
TS Technical Specification
UE User Equipment

### BACKGROUND

Conventionally, a beam alignment procedure between a gNB and a UE may have three phases P1 to P3 (see Table 1):

TABLE 1
Phases of beam alignment

| | | |
|---|---|---|
| P1 | Beam selection | gNB sweeps beam and UE selects a best |
| | | beam and reports it to gNB |
| P2 | Beam refinement | gNB refines beam (i.e., it sweeps a narrower |
| | for transmitter | beam over a narrower range) and UE selects |
| | (gNB) | the best beam and reports it to gNB |
| P3 | Beam refinement | gNB fixes the best beam and transmits repeatedly |
| | for receiver (UE) | a reference signal (CSI-RS) repeatedly thereon. |
| | | UE sweeps its receive beams and selects the |
| | | best receive beam. |

When a connection is established via the beam alignment procedure (P1-P2-P3 process), the P3 process allows a UE to perform a beam sweep as depicted in FIG. 1. This P3 process aims at identifying the best UE beam to maximize the received RSRP at the UE. During this process the base station repeats the same Downlink CSI-RS on the beam selected in P2 over several time intervals, typically over many OFDM symbols. For multi panel UEs, UE does panel scan typically during P1 process to determine its best panel and gNB's best SSB beam. The P3 procedure is then typically conducted with the panel found to be best during previously UE run panel scan.

During P3 process, the UE measures RSRP with each of its Rx beams as shown in FIG. 1. L1 SINR and other CSI parameters may also be measured. In 3GPP TS 38.822 UE feature list (rel15) is defined a fixed parameter maxNumberRxBeam which represents the recommended CSI-RS resource repetition number per resource set ranging from 2 to 8.

UEs with analogue beamforming can operate only one beam at a time. Hence the conventional P3 beam alignment procedure outlined hereinabove spans multiple time intervals (OFDM symbols) over which UE does measurements with one beam at a time. During this time, base station transmits the reference signal (aperiodic CSI-RS with repetition) on the beam selected in P2. It occupies resources, typically over an entire bandwidth part (BWP).

The UE signals the number X of OFDM symbols required for a complete P3 beam sweep as a static UE capability, maxNumberRxBeam, which can range typically from 2 to 8 but is in general not limited. Thus, the UE indicates a single value for the preferred number of NZP CSI-RS resource repetitions per CSI-RS resource set. I.e., X is equal to the number of beams. This procedure is typically repeated every time there is a handover, SSB beam switch, UE panel switch, or radio channel angular change due to blockers appearing during UE mobility, etc.

### SUMMARY

It is an object of the present invention to improve the prior art.

According to a first aspect of the invention, there is provided an apparatus comprising:
a determiner configured to determine, subsequently for each of X beams, a characteristic of a power of a reference signal received on the respective beam over a respective period of time; and
one or more processors, and memory storing instructions that, when executed by the one or more processors, cause the apparatus to perform:
identifying a best beam among the X beams such that the characteristic of the power of the best beam is extreme among the characteristics of the power received on the X beams over the respective period of time; wherein
X is an integer equal to or larger than 2;
each of the periods of time has a same duration denoted a slice duration;
the slice duration is shorter than a duration of one symbol of the reference signal.

According to a second aspect of the invention, there is provided an apparatus comprising:
one or more processors, and
memory storing instructions that, when executed by the one or more processors, cause the apparatus to perform:
monitoring whether an indication is received that a terminal has X beams;
monitoring whether a request to transmit N symbols of a reference signal for beam alignment of the terminal is received;
transmitting A symbols of the reference signal without transmitting more than the A symbols of the reference signal if the request to transmit N symbols is received, wherein
N is an integer equal to or larger than 1; X is an integer equal to or larger than 2; N<X;
A is an integer equal to or larger than N; A depends directly and unambiguously on N and does not depend directly on X; and
each of the A symbols of the reference signal is transmitted with a same spatial characteristic.

According to a third aspect of the invention, there is provided a method comprising:
determining, subsequently for each of X beams, a characteristic of a power of a reference signal received on the respective beam over a respective period of time; and
identifying a best beam among the X beams such that the characteristic of the power of the best beam is extreme among the characteristics of the power received on the X beams over the respective period of time; wherein
X is an integer equal to or larger than 2;
each of the periods of time has a same duration denoted a slice duration;
the slice duration is shorter than a duration of one symbol of the reference signal.

According to a fourth aspect of the invention, there is provided a method comprising:
monitoring whether an indication is received that a terminal has X beams;
monitoring whether a request to transmit N symbols of a reference signal for beam alignment of the terminal is received;
transmitting A symbols of the reference signal without transmitting more than the A symbols of the reference signal if the request to transmit N symbols is received, wherein
N is an integer equal to or larger than 1; X is an integer equal to or larger than 2; N<X;
A is an integer equal to or larger than N; A depends directly and unambiguously on N and does not depend directly on X; and
each of the A symbols of the reference signal is transmitted with a same spatial characteristic.

Each of the methods of the third and fourth aspects may be a method of beam alignment.

According to a fifth aspect of the invention, there is provided a computer program product comprising a set of instructions which, when executed on an apparatus, is configured to cause the apparatus to carry out the method according to any of the third and fourth aspects. The computer program product may be embodied as a computer-readable medium or directly loadable into a computer.

According to some embodiments of the invention, at least one of the following advantages may be achieved:
time required for beam alignment by the UE may be shortened;
cell throughput may be increased;
overhead of P3 related resources may be reduced;
compatible with conventional beam alignment by the UE;
robust method, may work even under poor radio conditions;
energy consumption of UE may be reduced;
no additional HW in UE may be needed.

In detail, some example embodiments of the invention reduce the number of OFDM symbols required to complete the P3 UE Rx beam sweeping procedure. Depending on the implementation and radio conditions, the number may be as low as 2 symbols. This gives more resources to the network scheduler for actual data transfer and thereby increases the cell throughput. Some example embodiments reduce the UE power consumption during the P3 procedure.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows a conventional P3 beam alignment procedure with fixed gNodeB beam and UE beam sweep;

FIG. 2 shows a resource grid used for a conventional P3 beam alignment procedure (top), a conventional P3 beam alignment procedure (middle), and a P3 beam alignment procedure according to some example embodiments of the invention (bottom);

FIG. 3 shows the time for scanning 8 beams using 512 samples for each beam according to some example embodiments of the invention;

FIG. 4 shows a state diagram according to some example embodiments of the invention;

FIG. 5 shows a flow diagram for states 1 and 2 of the state diagram of FIG. 4 in case of round robin beam sweeping;

FIG. 6 shows example embodiment 1 of the invention;

FIG. 7 shows example embodiment 2 of the invention;

FIG. 8 shows example embodiment 3 of the invention;

FIG. 9 shows example embodiment 4 of the invention;

FIG. 10 shows a detail of the digital logic of example embodiment 4 of the invention;

FIG. 11 shows an apparatus according to an example embodiment of the invention;

FIG. 12 shows a method according to an example embodiment of the invention;

FIG. 13 shows an apparatus according to an example embodiment of the invention;

FIG. 14 shows a method according to an example embodiment of the invention;

FIG. 15 shows an apparatus according to an example embodiment of the invention.

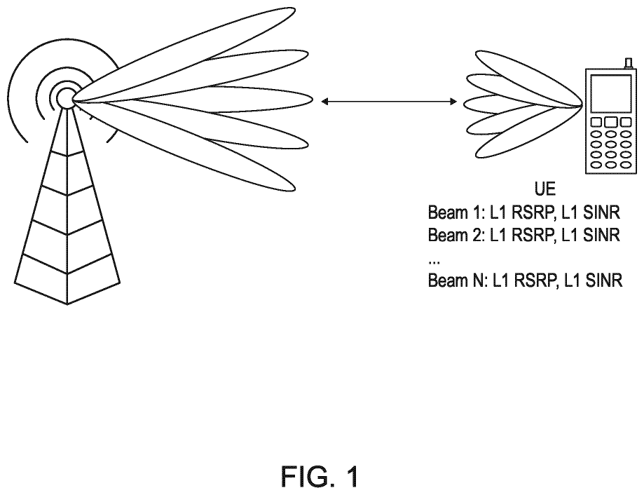

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

When several UEs in a cell need to align their respective Rx beams, the resource elements overhead grows linearly and becomes a very undesirable effect because these resources could otherwise be used, e.g. for data traffic, and thus could increase the system's spectral efficiency.

For example, if a UEs in a cell is moving at 36 km/h, it will require roughly 100 updates/second based on 10 updates/m. Thus, the P3 sweeps require 100*8 OFDM symbols per second if maxNumberRxBeam is 8. This is a large overhead for a beam alignment of one UE given that there are only 8000 slots (11200 OFDM symbols) per second with 120 KHz SCS used in FR2.

Thus, it is highly beneficial from both throughput and UE power consumption perspective if the P3 procedure can be carried out over as few time intervals as possible.

Some example embodiments of the invention reduce the number of time intervals (OFDM symbols) needed for a UE to complete the P3 beam sweep. For this purpose, UE having X beams uses the first N symbols with the aperiodic NZP CSI-RS to do the beam sweep. The UE measures the received power in each beam over a respective time period (“time slice”) of a same duration, denoted “slice duration”. According to some example embodiments N<X, so the duration available for each Rx beam (the “slice duration”) is smaller than the duration of a OFDM symbol.

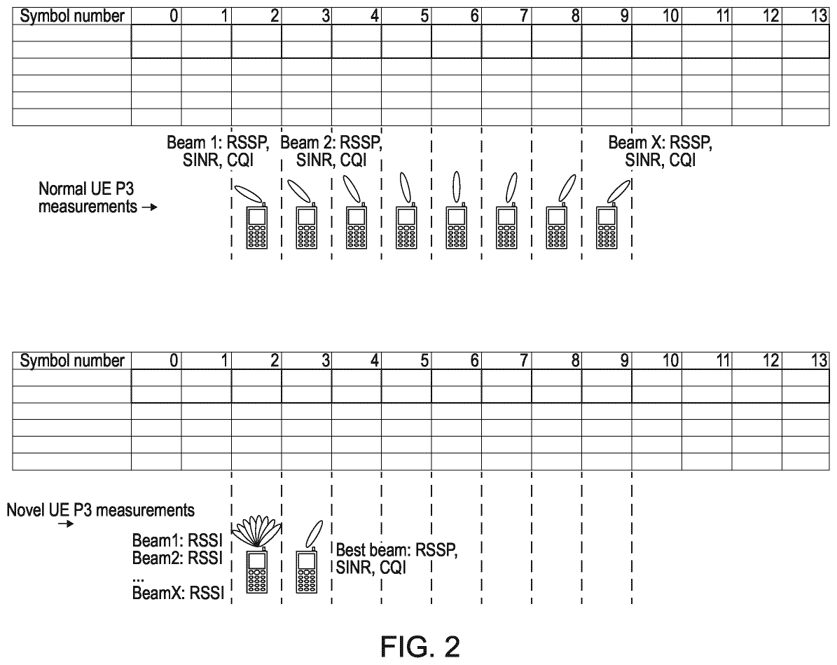

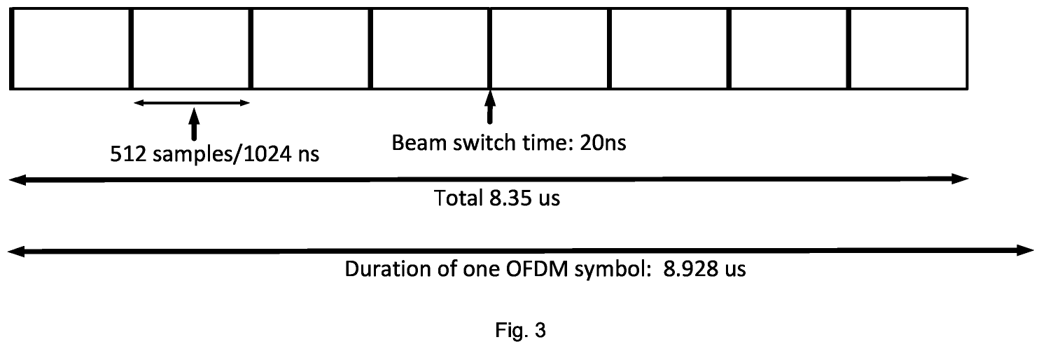

This is shown in FIG. 2. Here the conventional UE P3 measurements are shown in the top row, which require e.g. 8 OFDM symbols to do 8 measurements using 8 different UE Rx beams. Below that in FIG. 2, a process according to some example embodiments of the invention for N=1 is depicted. In this process, the first symbol of CSI-RS reception is used such that the UE sweeps its 8 different beams during the duration of the first OFDM symbol. E.g. if using numerology 3 (120 KHz SCS), this divides the 8.9 μs OFDM symbol into 8 time slices. During each time slice, new weights are applied to the phase shifters in the RFFE to form a Rx beam in a particular direction. During this time slice, only the RSSI (raw power) from that direction is measured. This can be done in a number of ways and some example embodiments are explained in detail further below. Note that the mean power transmitted over each OFDM symbol of the CSI-RS (i.e. over the plural time slices varies insignificantly and hence the variation which a UE sees from one time slice to the next time slice (i.e. from one beam to the next beam) is primarily induced by the beam switching.

After the RSSI is measured for each of the beams of the UE, the beam with maximum RSSI is determined (“best beam”). The best beam may then be used by the UE for the communication with the gNB in OFDM symbols following the determination of the best beam. In some example embodiments, after the determining the best beam and prior to PDSCH decoding, UE determines the channel quality of the best beam and measures at least one of SINR and CQI for the best beam and reports them to the gNB. Thus the overall time for completing the P3 Rx beam alignment can be reduced to just 1 or 2 OFDM symbols. This number is denoted A, i.e. N=1, A=2 in the present example if SINR and CQI for the best beam are measured and reported, and N=A=1 if SINR and CQI for the best beam are not measured and reported. A is an integer equal to or larger than N. For example, a conventional UE requests the network to transmit 8 repetitions of OFDM symbols of an aperiodic NZP-CSI-RS (if the UE has 8 beams to sweep), whereas the UE according to some example embodiments of the invention requests only A=2 repetitions of OFDM symbols of the aperiodic NZP-CSI-RS even if it has 8 beams to sweep.

Thus, some example embodiments of the invention provide in particular:
A dedicated procedure to handle aperiodic NZP-CSI-RS with retransmission for the purpose of P3 UE narrow beam alignment, in an optimized manner.
An option for the UE to signal a reduced number (compared to conventional P3 procedure) of retransmissions of the aperiodic NZP-CSI-RS with retransmission ON. For example, the parameter maxNumberRxBeam may be modified dynamically, or a new parameter may be introduced to distinguish the number of repetitions of NZP-CSI-RS from the number of beams of the UE.

The symbol rate (CSI-RS symbols) is relatively low compared with the sampling rate and fast switching time of RF front end components. This make solutions according to some example embodiments practical as illustrated by the numbers and facts summarized below:

| Switch time for “Of the shelf RF switches” is less than: | 20 | ns |
|---|---|---|
| Sample time for sampling the RF signal | 2.034 | ns |
| Number of samples per measured UE beam: | 512 | |
| Resulting time to be used for complete scan; 45° | 8.35 | μs |
| beamwidth, 8 beams: | | |

There is a reasonable margin because one OFDM symbol is 8.9 μs, as indicated above. The numbers used above are by no means exotic and, if dedicated HW is developed for procedures according to some example embodiments, even shorter sampling time and/or switching time may be expected. The sample time of 2 ns comes from known practical implementations. The number of samples used will obviously affect the amount of averaging. Thus, the number of samples required to have reasonable probability of false detection varies with RSSI. And there exists a Threshold below which this scheme should preferably not be used. This Threshold depends on implementation and may be stored in the respective apparatus, but is expected to be about 3 to 6 dB above the noise floor

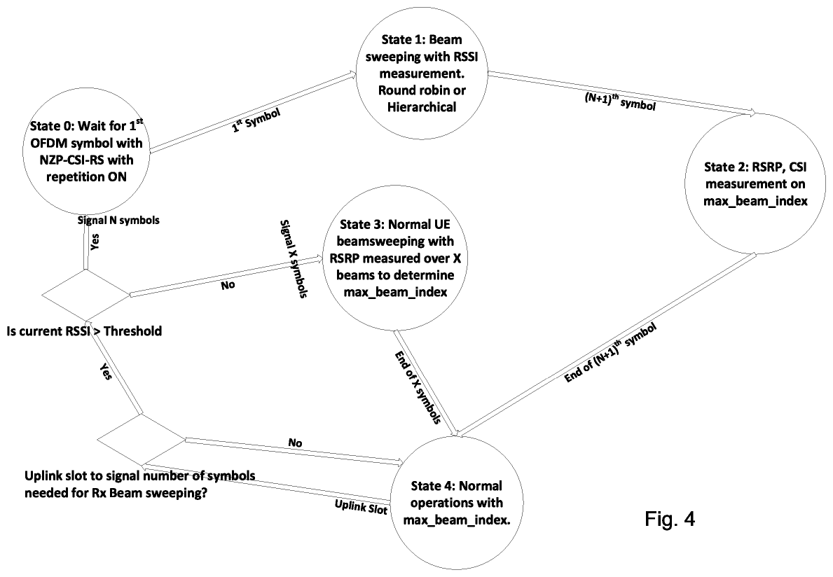

Details of the process are as depicted in the state diagram in FIG. 4. In FIG. 4, state 4 is the default state in which the current best beam (typically the previously determined best beam, but it may be any of the X beams) with index max_beam_idx is being used. When UE is to signal to the network the number A of symbols it needs for completing its Rx beamsweep, it checks if the current RSSI (i.e. the current received raw power) is greater than Threshold or not. If not, UE signals to gNB that it needs X symbols and uses 1 symbol per Rx beam for doing RSRP measurements in state 3 (as conventionally). Note that a beam is used by applying its corresponding codeword to the phase shifters of the (antenna) panel of the UE.

If the current RSSI is greater than Threshold then UE signals to gNB that it needs A symbols, where A≤X. The value of A may be dependent indirectly on the number of Rx beams X and/or directly or indirectly on the current RSSI. As another option, it may be statically configured to be a fixed value, e.g. A=2. It then moves to state 0 where it waits for the first symbol of the NZP-CSI-RS.

When the first symbol of the aperiodic NZP-CSI-RS is scheduled and the current RSSI is greater than the threshold, the process moves to state 1 in which the first phase of the scheme is carried out. In state 1, the raw power measurements (RSSI) are done during the first N symbols over X different beams. The beam switching can be done in any feasible way, such as in round robin fashion or in a hierarchical way. After N symbols the scheme moves to state 2 in which the RLM measurements (i.e. RSRP, CSI) are done. State 2 is optional and may be omitted in some example embodiments of the invention. In this case, A=N. For example, state 2 may be omitted if the best beam is the same as the previous best beam and the current RSSI of the best beam is substantially as large as the previous RSSI of the best beam. If State 2 is omitted, the process moves from State 1 directly to State 4.

Thus, depending on implementation, UE may signal to gNB either the number N=A of OFDM symbols required to determine the best beam, or the number A required to determine the best beam and to determine the channel quality on the best beam. A and N depend directly and unambiguously from each other (e.g. A=N if the channel quality of the beast beam is not determined, or A=N+1 if one additional OFDM symbol is required to determine the channel quality). A does not depend directly on X. If UE transmits N, gNB has to derive the number A of required repetitions of OFDM symbols of the reference signal from the known direct and unambiguous relationship between N and A.

Some example embodiments of the invention are explained with CSI-RS used as the reference signal for P3 of the beam alignment procedure. However, the invention is not limited to CSI-RS. The reference signal may be arbitrary if it fulfills the following conditions:
Repetition on, i.e., the reference signal is repeated multiple times.
It is transmitted in each repetition with the same spatial characteristic. I.e. the same gNB beam is used for all repetitions.
It is a NZP signal.
The mean power transmitted over the OFDM symbol duration varies insignificantly and hence the variation which a UE sees from 1 time slice to next is primarily induced by the beam switching if the beams have a reasonable angular distance (e.g. at least 5°, or at least) 10°. For example, if the UE is at least 20 m away from the gNB's antenna panel, the reduction of the RSSI between the optimum beam and a beam deviating from the optimum beam by at least 5° is at least 20% larger (preferably at least 33% larger) than the deviations of the integrated power over a slice duration within each OFDM symbol of the reference signal. The optimum beam is a (hypothetical) beam where the RSSI has an absolute maximum. The optimum beam may be different from the best beam because the beams cover only discrete angels.

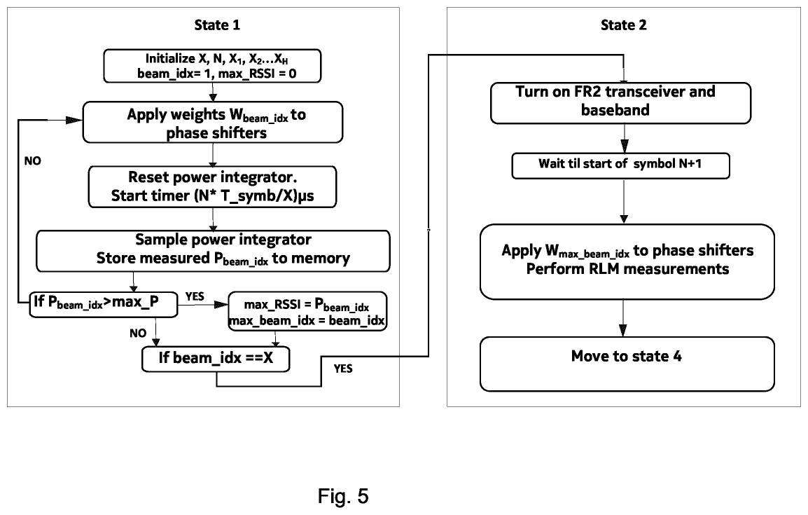

The detailed actions in states 1 and 2 of FIG. 4 are given in FIG. 5 for round robin beam sweeping. Here, W_{beam_idx} is the weight applied to analog phase shifters corresponding to beam with index beam_idx. T_symb is the OFDM symbol duration corresponding to a particular SCS. E.g., the OFDM symbol duration is 8.9 us for 120 KHz SCS. Finally P_{beam_idx} is the measured power for beam with index beam_idx. P_{beam_idx} may be a sum of measured power per polarization or may be a power measured after the signals from the different polarizations are combined.

For hierarchical beam sweeping, the steps for state 1 are as follows:
1) Initialize value of X, N, X₁, X₂ . . . X_{H}. These can be statically or dynamically configured
   a. X₁, X₂ . . . . X_{H} are the number of beams in each hierarchy. And H are the number of hierarchies

$$b . X = {X}_{1} + {X}_{2 +} … + {X}_{H} .$$

2) Initialize hierarchy index y=1, max_RSSI=0
3) Initialize beam_index={1,0, . . . , 0} is a vector of length H and contains indexes with in each hierarchy. A beam at hierarchy y will have 0's at indexes y+1 to H.
4) Scan all X_{y} beams at hierarchy y and find the index max_{y} which gives maximum max_RSSI_{y} at hierarchy y. This can be done similar to the steps in state 1 of round robin search.
5) IF max_RSSI_{y}>max_RSSI THEN
   a. max_RSSI=max_RSSI_{y}
   b. beam_index={max1, . . . max_{y}, 0,0,0}
   c. IF y≠H THEN y=y+1, go to step 4
6) max_beam_index=beam_index

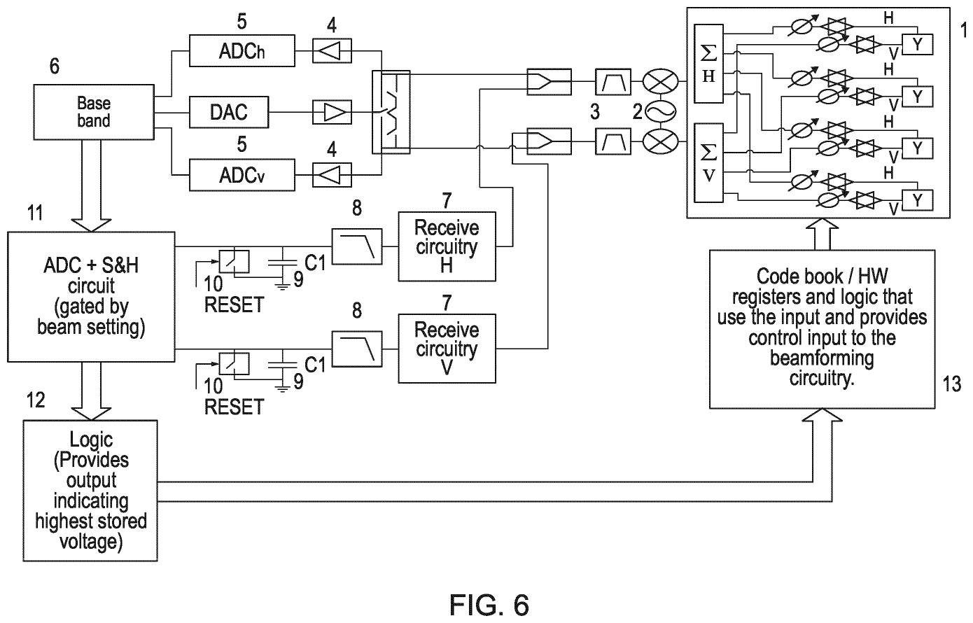

FIGS. 6 to 10 depict different implementations according to some example embodiments of the invention. The same reference signs are used for corresponding components in FIGS. 6 to 10. Each of these example embodiments can be used for any type of beam sweeping, such as round robin beam sweeping as well as hierarchical beam sweeping.

### Example Embodiment 1 (FIG. 6)

For each polarization, the output of each FR2 RFFE panel 1 is routed to a mixer 2 which produces IF output and is further routed to a tunable bandpass filter 3. If the IF is less than 7 GHz then the bandpass filter 3 may be implemented for example using 5 GHZ Wifi filter or Band 41 filter etc. The bandpass filter 3 may be tuned to eliminate interference outside of the CSI-RS bandwidth.

The output of bandpass filters 3 for horizontal and vertical polarization is routed to a conventional FR2 transceiver 4 and further through ADC/DAC 5 to baseband unit 6. The output of the bandpass filter 3 is additionally routed to a parallel receive circuitry 7 for further down conversion, if necessary, e.g. a low IF receiver, single or dual conversion receiver followed by a diode detector, a ASK receive circuitry. This is then fed via a low pass filter 8 to a power integrator 9 with a reset switch 10. The integrator 9 may be implemented using a capacitor which does an analogue raw power measurement (RSSI). The output voltage of the capacitor is then sampled by a ADC with sample and hold circuitry 11 at the end of each time slice. After each measurement, the integrator 9 is reset before starting measurement on the next beam.

The sampled output for each polarization is stored in digital logic 12 which also provides the max_beam_index with highest power from the number of beams measured so far. It sums up the measured voltage for each polarization per beam. The storage in this logic box is reset before the entire P3 procedure begins.

The next digital logic box 13 in the chain is responsible for controlling the beam sweeping procedure in the two states described above. In state 1, it chooses the next beam for power measurement, while in state 2 it chooses the best beam for doing RSRP and/or CSI measurements in the baseband.

This solution may also save power of the UE because all of the FR2 transceiver chain 4, 5 after the bandpass filter 3 and the baseband unit 6 are not required to be turned on when the UE is in state 1.

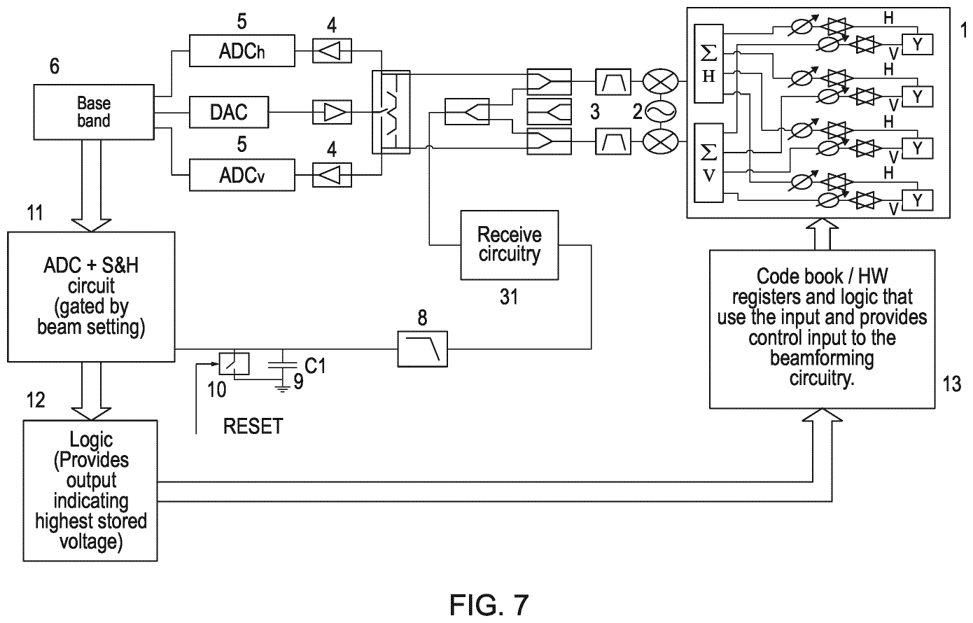

### Example Embodiment 2 (FIG. 7)

This example embodiment is very similar to Example embodiment 1. A difference is that instead of routing the output of the bandpass filter 3 directly to the integrator circuitry 9 for each polarization, the outputs of the bandpass filters 3 for H polarization and V polarization are added in a power splitter 31 (combiner) and the output of the power splitter 31 is routed to the power integrator 9 afterwards (if needed via receive circuitry 7 and low pass filter 8). This reduces the number of integrators 9, reset switches 10, and ADCs 11. Only one of them is needed instead of one of them per polarization.

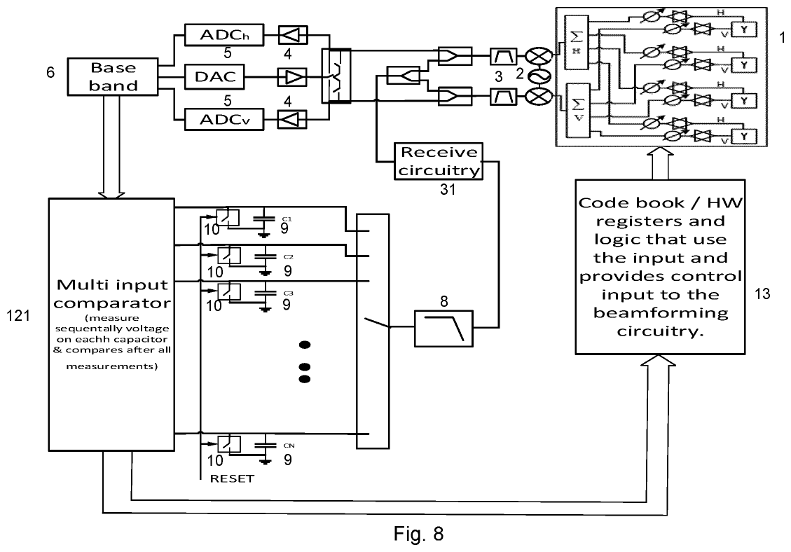

### Example Embodiment 3 (FIG. 8)

Example embodiment 3 is also similar to Example embodiment 1 in most aspects. The difference is in the integrator 9 (with corresponding reset switch 10) and the logic 121 to select the max_beam_index. It has 1 integrator 9 per beam with its corresponding reset switch 10. All the integrators 9 are reset before the beam sweeping procedure begins. So the time for resetting the integrators 9 during beam sweeping itself, as done in example embodiment 1, is eliminated from the beam sweeping procedure. The integrators 9 are fed via a multi level switch which is controlled by the logic which chooses the codeword for next beam. The output of the integrators 9 is then compared using a multi input comparator 121. It replaces the digital logic 12 for finding the max_beam_index according to example embodiments 1 and 2.

Thus, the procedure for state 1 of FIG. 4 is slightly altered as follows:
1) Reset of power integrators 9 is done only one time while entering state 1.
2) After each power measurement, the multi level switch 91 is reconfigured to send the output of the receiver circuitry to the integrator 9 corresponding to the beam being measured.

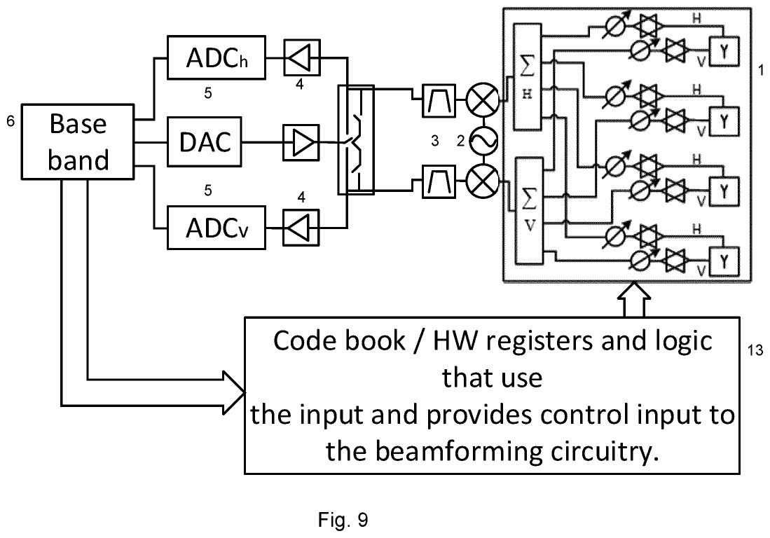

### Example Embodiment 4 (FIG. 9)

This example embodiment is different from example embodiments 1 to 3 because it implements the entire process in digital logic. The digital logic may be implemented in the baseband unit 6.

In this example embodiment, the FR2 transceiver 4 as well as the baseband unit 6 are turned on for doing the P3 beam sweeping scheme described hereinabove. The RSSI measurement for each beam is done on the complex values (IQ samples) sampled by the ADC 5. This is done in the digital logic on the baseband.

The baseband unit 6 also controls, in the state 1, the process of determining the next beam.

This example embodiment does not require any new hardware (such as the integrator 9 with reset switch 10) to be added specifically for the P3 procedure because all the additional digital logic may be implemented in the baseband unit 6. However, the entire chain from RFFE 1 via Transceiver 4 to baseband unit 6 is turned on in State 1 such that energy consumption may be higher than for example embodiments 1 to 3.

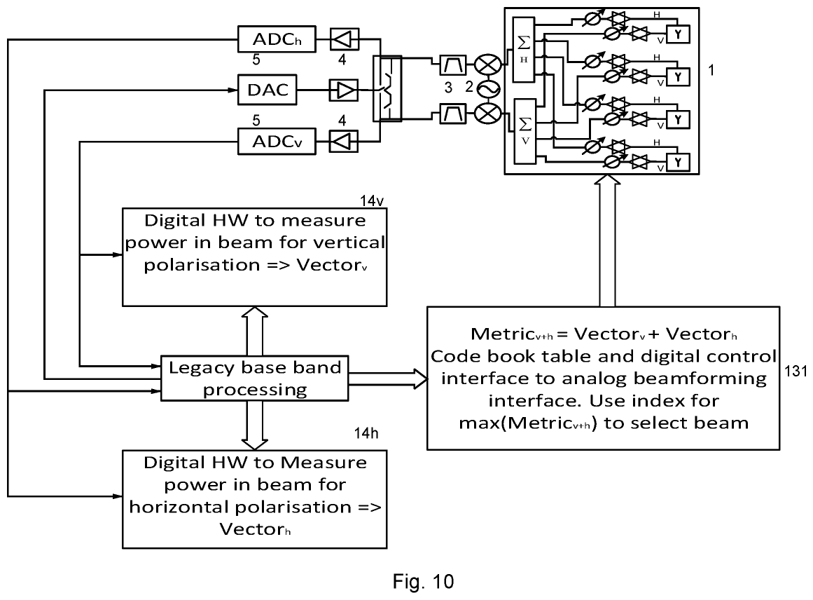

FIG. 10 shows more details of how Embodiment 4 may be realized in the baseband unit 6. For each polarization, a respective new logic 14v, 14h is added which measures the raw power in each beam (enumeration number). This performs similar operation to the integrator circuit in other embodiments, whereby power of each digital sample is measured and summed up. Other options than such summing up are measuring average power by a digital logic or determining maximum instantaneous power by a digital logic. The vector of summed up power (or average power, or maximum instantaneous power, or a combination of any of these options) over multiple beams for each polarization is fed to another logic box 131 which determines the best beam to use. This logic box may also be used to control the analogue beamforming and its timing.

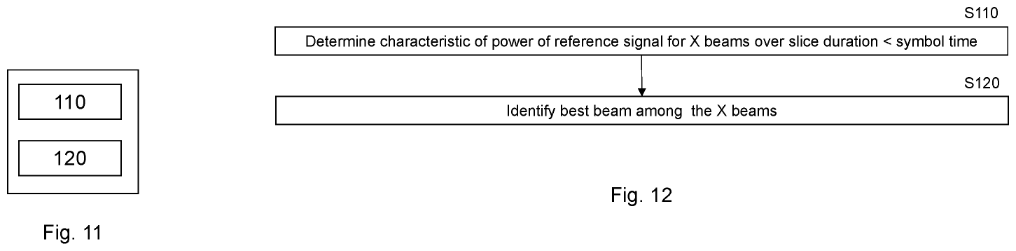

FIG. 11 shows an apparatus according to an example embodiment of the invention. The apparatus may be a terminal, such as a UE or an MTC device, or an element thereof. FIG. 12 shows a method according to an example embodiment of the invention. The apparatus according to FIG. 11 may perform the method of FIG. 12 but is not limited to this method. The method of FIG. 12 may be performed by the apparatus of FIG. 11 but is not limited to being performed by this apparatus.

The apparatus comprises means for determining 110 and means for identifying 120. The means for determining 110 and means for identifying 120 may be a determining means and identifying means, respectively. The means for determining 110 and means for identifying 120 may be a determiner and identifier, respectively. The means for determining 110 and means for identifying 120 may be a determining processor and identifying processor, respectively.

The means for determining 110 determines, subsequently for each of X beams, a characteristic of a power of a reference signal received on the respective beam over a respective period of time (S110). X is an integer equal to or larger than 2. Each of the periods of time has a same duration denoted a slice duration. The slice duration is shorter than a duration of one symbol of the reference signal.

The means for identifying 120 identifies a best beam among the X beams such that the determined characteristic of the power of the best beam is extreme among the characteristics of the powers received on the X beams over the respective period of time (S120). I.e., the means for identifying 120 identifies the best beams as the beam on which the determined characteristic of the power of S110 is extreme among the X beams. “Extreme” may mean “minimum” or maximum.

For example, the characteristic of the power of the reference signal may comprise at least one of
an integral of the power on the respective beam over the respective period of time,
an average of the power on the respective beam over the respective period of time, and
a maximum of the power on the respective beam over the respective period of time.

In these example cases, the characteristic of the power of the best beam is typically maximum among the characteristics of the power received on the X beams over the respective period of time.

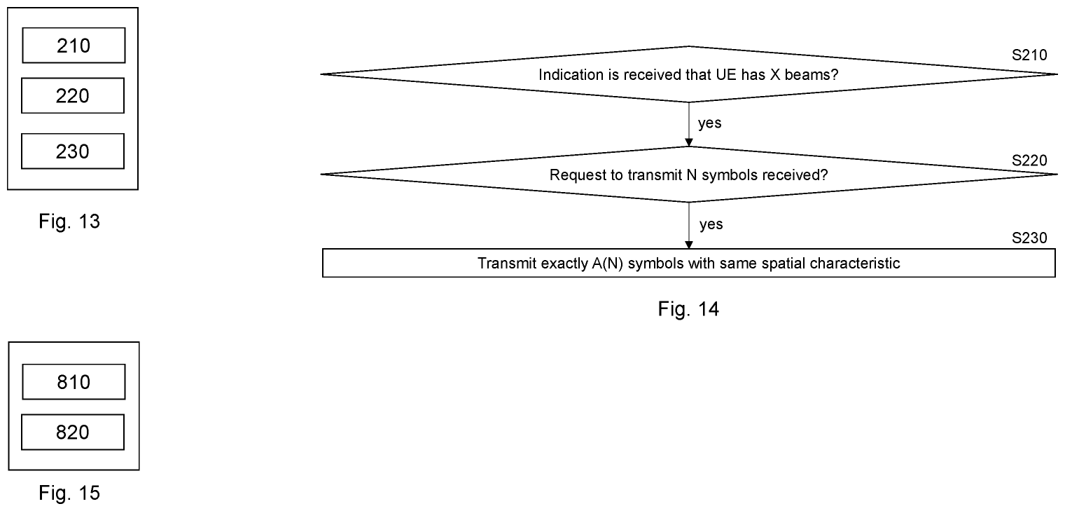

FIG. 13 shows an apparatus according to an example embodiment of the invention. The apparatus may be a base station, such as a gNB or an eNB, or an element thereof. FIG. 14 shows a method according to an example embodiment of the invention. The apparatus according to FIG. 13 may perform the method of FIG. 14 but is not limited to this method. The method of FIG. 14 may be performed by the apparatus of FIG. 13 but is not limited to being performed by this apparatus.

The apparatus comprises first means for monitoring 210, second means for monitoring 220, and means for transmitting 230. The first means for monitoring 210, second means for monitoring 220, and means for transmitting 230 may be a first monitoring means, second monitoring means, and transmitting means, respectively. The first means for monitoring 210, second means for monitoring 220, and means for transmitting 230 may be an first monitor, second monitor, and transmitter, respectively. The first means for monitoring 210, second means for monitoring 220, and means for transmitting 230 may be a first monitoring processor, second monitoring processor, and transmitting processor, respectively.

The first means for monitoring 210 monitors whether an indication is received that a terminal has X beams (S210). The second means for monitoring 220 monitors whether a request to transmit N symbols of a reference signal for beam alignment of the terminal is received (S220). N is an integer equal to or larger than 1. X is an integer equal to or larger than 2. N is smaller than X (N<X).

S210 and S220 may be performed in an arbitrary sequence. They may be performed fully or partly in parallel.

If the request to transmit N symbols is received (S220=yes), the means for transmitting 230 transmits A symbols of the reference signal without transmitting more than the A symbols of the reference signal (S230). I.e., the means for transmitting 230 transmits exactly A symbols of the reference signal. The means for transmitting 230 transmits each of the A symbols of the reference signal with a same spatial characteristic. Typically, the A symbols are transmitted consecutively. A is an integer equal to or larger than N. A depends directly and unambiguously on N and does not depend directly on X.

FIG. 15 shows an apparatus according to an embodiment of the invention. The apparatus comprises at least one processor 810, at least one memory 820 including computer program code, and the at least one processor 810, with the at least one memory 820 and the computer program code, being arranged to cause the apparatus to at least perform at least the method according to at least one of FIGS. 12 and 14 and related description.

Typically, the UE informs the gNB on the required number of repeated OFDM symbols (i.e. on N or A, depending on implementation), and gNB repeats only A transmissions, but not more than A transmissions. In some example embodiments, UE does not inform gNB on N or A, or gNB ignores this information. In these example embodiments, gNB transmits X (number of beams) OFDM symbols of the reference signal, as conventionally. In such embodiments, UE may ignore X-A transmissions, e.g. the transmissions after the first A transmissions. Thus, the UE still may save energy compared to a UE employing a conventional method evaluating the X transmissions.

Some example embodiments are explained with respect to a 5G network. However, the invention is not limited to 5G. It may be used in other radio networks, too, e.g. in previous of forthcoming generations of 3GPP networks such as 4G, 6G, or 7G, etc, if a UE uses plural beams. It may be used in non-3GPP mobile communication networks if the respective base station (e.g. access point etc.) transmits a reference signal for beam alignment by the terminal.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, a terminal (such as a UE or a MTC device) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a base station (such as a gNB or eNB) or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

The phrase “at least one of A and B” comprises the options only A, only B, and both A and B. The terms “first X” and “second X” include the options that “first X” is the same as “second X” and that “first X” is different from “second X”, unless otherwise specified.

1. Apparatus comprising:
a determiner configured to determine, subsequently for each of X beams, a characteristic of a power of a reference signal received on the respective beam over a respective period of time; and
one or more processors, and memory storing instructions that, when executed by the one or more processors, cause the apparatus to perform:
identifying a best beam among the X beams such that the characteristic of the power of the best beam is extreme among the characteristics of the power received on the X beams over the respective period of time; wherein
X is an integer equal to or larger than 2;
each of the periods of time has a same duration denoted a slice duration;
the slice duration is shorter than a duration of one symbol of the reference signal.

2. The apparatus according to claim 1, wherein, for each of the X beams, the characteristic of the power of the reference signal comprises at least one of
an integral of the power on the respective beam over the respective period of time,
an average of the power on the respective beam over the respective period of time, and
a maximum of the power on the respective beam over the respective period of time; and
the characteristic of the power of the best beam is maximum among the powers received on the X beams over the respective period of time.

3. The apparatus according to claim 2, wherein the characteristic of the reference signal comprises the integral of the power, and the determiner comprises an analogue circuit for integrating, for at least one of the X beams, the power of the reference signal received on the respective beam over the respective period of time.

4. The apparatus according to claim 1, wherein the instructions, when executed by the one or more processors, further cause the apparatus to perform:
receiving at least one symbol of the reference signal on the best beam after the best beam is identified;
determining at least one of a reference signal received power, a signal over interference and noise ratio, and a channel quality indicator based on the at least one symbol of the reference signal received on the best beam after the best beam is identified.

5. The apparatus according to claim 4, wherein the instructions, when executed by the one or more processors, further cause the apparatus to perform:
inhibiting the determining the at least one of the reference signal received power, the signal over interference and noise ratio, and the channel quality indicator for each of the X beams while the best beam has not been identified.

6. The apparatus according to claim 4, wherein the determining the at least one of the reference signal received power, the signal over interference and noise ratio, and the channel quality indicator is performed by a digital circuit.

7. (canceled)

8. The apparatus according to claim 1, wherein the instructions, when executed by the one or more processors, further cause the apparatus to perform:
determining a power of the reference signal received on one of the X beams;
checking whether the power of the reference signal received on the one of the X beams is larger than a threshold stored in the apparatus;
if the power of the reference signal received on the one of the X beams is not larger than the stored threshold:
determining, subsequently for each of the X beams, at least one of a respective signal to interference and noise ratio and a reference signal received power over a duration of at least one symbol of the reference signal;
identifying the best beam among the X beams such that at least one of the at least one of the signal to interference and noise ratio and the reference signal received power of the best beam is maximum among the determined signal to interference and noise ratios and the reference signal received powers; and
inhibiting the identifying the best beam among the X beams such that the characteristic of the power of the best beam is extreme among the powers received on the X beams over the respective period of time having the slice duration.

9. (canceled)

10. The apparatus according to claim 8, wherein
a digital circuit is configured to perform the determining, subsequently for each of the X beams, the at least one of the respective signal to interference and noise ratio and the reference signal received power over the duration of at least one symbol of the reference signal, and wherein
the instructions, when executed by the one or more processors, further cause the apparatus to perform if the power of the reference signal received on the one of the X beams is larger than the stored threshold:
switching off the digital circuit while the analogue circuit of the determiner integrates, subsequently for each of the X beams, the power of the reference signal received on the respective beam.

11. The apparatus according to claim 1, wherein the slice duration depends on a strength indicator of the reference signal such that if the strength indicator increases the slice duration does not increase.

12. The apparatus according to claim 1, wherein the slice duration is stored in the apparatus.

13. The apparatus according to claim 1, wherein the slice duration is N/X times the duration of one symbol of the reference signal, N is an integer equal to or larger than 1, and N<X.

14. The apparatus according to claim 1, wherein the instructions, when executed by the one or more processors, further cause the apparatus to perform:
receiving a signal of a physical downlink shared channel on the best beam;
decoding the received signal of the physical downlink shared channel.

15-16. (canceled)

17. Method comprising:
determining, subsequently for each of X beams, a characteristic of a power of a reference signal received on the respective beam over a respective period of time; and
identifying a best beam among the X beams such that the characteristic of the power of the best beam is extreme among the characteristics of the power received on the X beams over the respective period of time; wherein
X is an integer equal to or larger than 2;
each of the periods of time has a same duration denoted a slice duration;
the slice duration is shorter than a duration of one symbol of the reference signal.

18. The method according to claim 17, wherein, for each of the X beams, the characteristic of the power of the reference signal comprises at least one of
an integral of the power on the respective beam over the respective period of time,
an average of the power on the respective beam over the respective period of time, and
a maximum of the power on the respective beam over the respective period of time; and
the characteristic of the power of the best beam is maximum among the powers received on the X beams over the respective period of time.

19. The method according to claim 18, wherein the characteristic of the reference signal comprises the integral of the power, and the determining is performed by a determiner comprising an analogue circuit for integrating, for at least one of the X beams, the power of the reference signal received on the respective beam over the respective period of time.

20. The method according to claim 17, further comprising:
receiving at least one symbol of the reference signal on the best beam after the best beam is identified;
determining at least one of a reference signal received power, a signal over interference and noise ratio, and a channel quality indicator based on the at least one symbol of the reference signal received on the best beam after the best beam is identified.

21. The method according to claim 20, further comprising:
inhibiting the determining the at least one of the reference signal received power, the signal over interference and noise ratio, and the channel quality indicator for each of the X beams while the best beam has not been identified.

22. The method according to claim 20, wherein the determining the at least one of the reference signal received power, the signal over interference and noise ratio, and the channel quality indicator is performed by a digital circuit.

23. (canceled)

24. The method according to claim 17, further comprising:
determining a power of the reference signal received on one of the X beams;
checking whether the power of the reference signal received on the one of the X beams is larger than a threshold stored in the method;
if the power of the reference signal received on the one of the X beams is not larger than the stored threshold:
determining, subsequently for each of the X beams, at least one of a respective signal to interference and noise ratio and a reference signal received power over a duration of at least one symbol of the reference signal;
identifying the best beam among the X beams such that at least one of the at least one of the signal to interference and noise ratio and the reference signal received power of the best beam is maximum among the determined signal to interference and noise ratios and the reference signal received powers; and
inhibiting the identifying the best beam among the X beams such that the characteristic of the power of the best beam is extreme among the powers received on the X beams over the respective period of time having the slice duration.

25. (canceled)

26. The method according to claim 24, wherein
a digital circuit is configured to perform the determining, subsequently for each of the X beams, the at least one of the respective signal to interference and noise ratio and the reference signal received power over the duration of at least one symbol of the reference signal, and
the method further comprises, if the power of the reference signal received on the one of the X beams is larger than the stored threshold:
switching off the digital circuit while the analogue circuit of the determiner integrates, subsequently for each of the X beams, the power of the reference signal received on the respective beam.

27. The method according to claim 17, wherein the slice duration depends on a strength indicator of the reference signal such that if the strength indicator increases the slice duration does not increase.

28. The method according to claim 17, wherein the slice duration is stored in an apparatus performing the method.

29. The method according to claim 17, wherein the slice duration is N/X times the duration of one symbol of the reference signal, N is an integer equal to or larger than 1, and N<X.

30. The method according to claim 17, further comprising:
receiving a signal of a physical downlink shared channel on the best beam;
decoding the received signal of the physical downlink shared channel.

31-32. (canceled)

33. A non-transitory computer program product comprising a set of instructions which, when executed on an apparatus, is configured to cause the apparatus to carry out the method according to claim 17.

34. (canceled)
